(19) United States
(12) Patent Application Publication
(10) Pub. No.: US 2016/0137094 A1
(43) Pub. Date: May 19, 2016

(54) VEHICLE

(71) Applicant: TOYOTA JIDOSHA KABUSHIKI KAISHA, Toyota-shi (JP)

(72) Inventor: Takehito YODA, Okazaki-shi (JP)

(73) Assignee: TOYOTA JIDOSHA KABUSHIKI KAISHA, Toyota-shi (JP)

(21) Appl. No.: 14/855,472

(22) Filed: Sep. 16, 2015

(30) Foreign Application Priority Data
Nov. 17, 2014 (JP) 2014-232399

(51) Int. Cl. B60L 11/18; B60H 1/24; H01M 10/6563; B60K 1/04; H01M 10/613

(52) U.S. Cl. CPC B60L 11/1874; B60L 11/1877; B60K 1/04; H01M 10/613; H01M 10/6563; B60H 1/246; B60K 2001/0433

(57) ABSTRACT

There is provided a vehicle enabling to relieve occupant's unpleasant feeling caused by noise generated from a blower and leaking in a vehicle interior. The vehicle including: an on-board battery; a blower provided with an air-intake opening portion for blowing air taken from the air-intake opening portion toward the on-board battery; and a wall member placed in front of the air-intake opening portion so that the on-board battery and the blower are partitioned from the vehicle interior, the wall member configured with an air intake port opening into the air-intake opening portion to bring the air in the vehicle interior into the air-intake opening portion, wherein the blower is placed such that an axis of the air-intake opening portion passes through the air intake port and obliquely intersects with a vehicle interior floor surface which is located lower than the air intake port.

### CROSS-REFERENCE TO RELATED APPLICATIONS

This application is based upon and claims the benefit of priority from the prior Japanese Patent Application No. 2014-232399, filed on Nov. 17, 2014, the entire contents of which are incorporated herein by reference.

### BACKGROUND OF THE INVENTION

1. Field of the Invention

The present invention relates to a vehicle such as a hybrid electric vehicle and an electric vehicle which are loaded with an on-board battery for driving a vehicle.

2. Related Art

Heretofore, some hybrid electric vehicles and electric vehicles are each provided below a rear seat with an on-board battery (battery) for vehicle driving. Some of those vehicles are arranged such that cooling air taken from a vehicle interior is blown toward the on-board battery to cool the on-board battery.

For example, Patent Document 1 discloses a cooling structure for a battery configured in such a way that a battery accommodation chamber is provided to accommodate batteries below a rear seat of a vehicle in which one corner of the battery accommodation chamber is divided to define a cooling air introduction chamber, a wall material of the battery accommodation chamber defining the cooling air introduction chamber is provided with an air intake slit opening into the vehicle interior, and an air intake port of a cooling blower is arranged to front toward the cooling air introduction chamber.

### RELATED ART DOCUMENTS

### Patent Documents

Patent Document 1: JP-A-2002-166728

### SUMMARY OF INVENTION

### Problems to be Solved by the Invention

However, in a vehicle configured to intake cooling air from a vehicle interior by use of a blower as mentioned above, there is a problem that occupants suffer from unpleasant feeling caused by noise generated in the blower and leaking into the vehicle interior.

The present invention has been made in view of the above problem and has a purpose to provide a vehicle provided with an on-board battery and a blower for blowing air toward the on-board battery, wherein the vehicle is enabled to relieve occupants' unpleasant feeling caused by noise generated in the blower and leaking into a vehicle interior.

### Means of Solving the Problems

One aspect of the invention provides a vehicle including: an on-board battery; a blower provided with an air-intake opening portion for blowing air taken from the air-intake opening portion toward the on-board battery; and a wall member placed in front of the air-intake opening portion so that the on-board battery and the blower are partitioned from a vehicle interior, the wall member configured with an air intake port opening into the air-intake opening portion to bring the air in the vehicle interior into the air-intake opening portion, wherein the blower is placed such that an axis of the air-intake opening portion passes through the air intake port and obliquely intersects with a vehicle interior floor surface which is located lower than the air intake port.

In this vehicle, the blower is placed as mentioned above, and therefore the noise coming out of the air-intake opening portion of the blower advances toward the vehicle interior floor surface. Accordingly, it becomes possible to reduce the noise reaching the passenger directly or at a short distance. Thus, the noise can be reduced by such a simple method of adjusting a posture of the blower, and hence a noise countermeasure with high cost-effectiveness can be obtained.

Further, of the vehicle interior floor surface, at least a portion where the axis intersects is preferably applied with a floor carpet. In this case, namely, the floor carpet acts as a sound absorber, leading to further reduction in the noise.

Further, in the above mentioned vehicle, preferably, the blower is a sirocco fan in which the air-intake opening portion is circularly opening, and the axis of the air-intake opening portion is a rotary axis of a fan motor of the sirocco fan.

Further, in any one of the above mentioned vehicle, preferably, the on-board battery and the blower are placed below a seat, and the wall member serves as a side panel positioned below the seat and the wall member is provided with the air intake port placed lower than a seating surface of the seat and higher than the vehicle interior floor surface.

Further, in any one of the above mentioned vehicle, preferably, the wall member includes a louver placed in the air intake port and formed of a plurality of fan blades, and an installation angle θw of the respective fan blades is equal to an intersection angle θ₁ formed by the axis of the air-intake opening portion and the vehicle interior floor surface (θw=θ₁).

### BRIEF DESCRIPTION OF THE DRAWINGS

FIG. 1 is an explanatory view showing a vehicle in an embodiment;

FIG. 2 is an explanatory view showing a battery module in which on-board batteries are assembled and a battery module case accommodating the battery module, as well as a cooling duct connected to the battery module case and a cooling blower in the embodiment;

FIG. 3 is a sectional view of a part below a rear seat of the vehicle when it is seen from a left side of the vehicle in the embodiment; and

FIG. 4 is a sectional view of a part below a rear seat of a vehicle when it is seen from a left side of the vehicle for which the present invention is not adopted.

### DESCRIPTION OF EMBODIMENTS

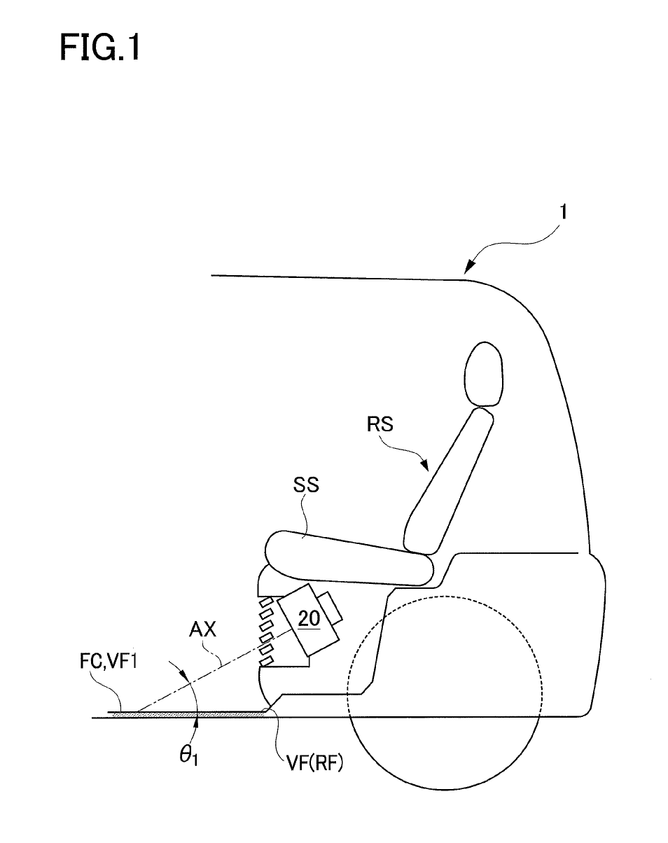

A detailed embodiment of the present invention is now explained with reference to the accompanying drawings. FIG. 1 shows a vehicle 1 according to the present embodiment. This vehicle 1 is a hybrid electric vehicle loaded with an on-board battery BT for driving a vehicle. Further, the vehicle 1 is a station wagon (two-box vehicle) in which a passenger room and a luggage room are integrated and the on-board battery BT and a cooling blower 20 for cooling the battery BT are placed below a rear seat RS.

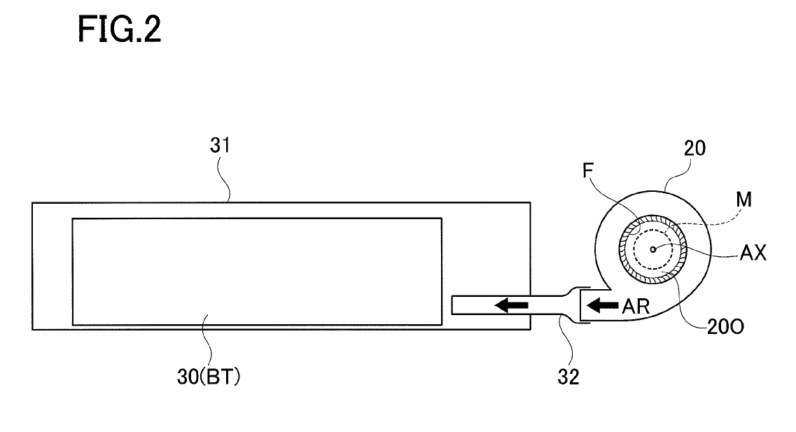

In this vehicle 1, in disposing the on-board battery BT and the cooling blower 20 in a part below the rear seat RS as shown in FIG. 2, a battery module 30 as a battery pack in which a plurality of the on-board batteries BT are assembled is accommodated in a metal-made battery module case 31. This battery module case 31 has one end connected to the cooling blower 20 via a cooling duct 32. These elements are placed in the part below the rear seat RS such that a side at which the cooling blower 20 is placed is located at a left side of the vehicle 1.

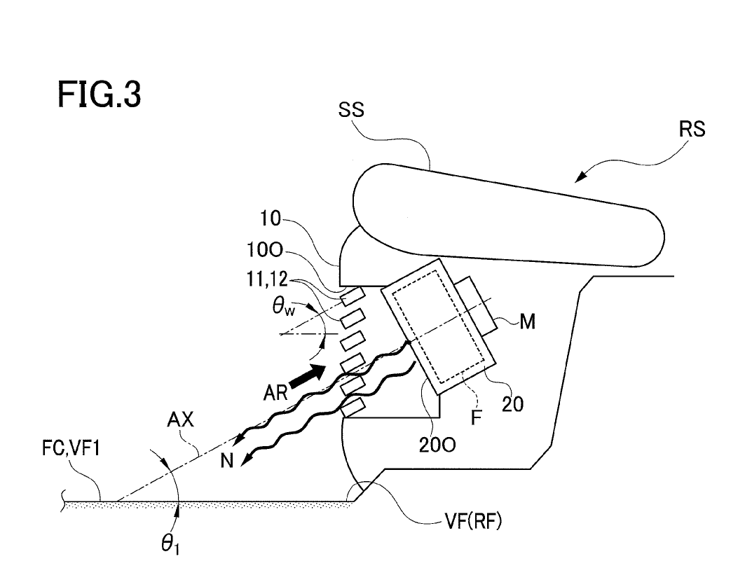

As shown in FIGS. 2 and 3, the cooling blower 20 as a sirocco fan includes an air-intake opening portion 20O opening circularly. Inside the air-intake opening portion 20O, a multiblade fan F and a fan motor M directly connected to the fan F are placed. Specifically, an axis AX of the fan F and the air-intake opening portion 20O constitutes a rotary axis of the fan motor M. The cooling blower 20 blows air AR which is taken through the air-intake opening portion 20O toward the battery module 30 (on-board battery BT) via the cooling duct 32 by rotating the fan F.

FIG. 3 is a left-side sectional view of a part below the rear seat RS of the vehicle 1. As shown in FIG. 3, the cooling blower 20 is mounted such that the air-intake opening portion 20O faces slantingly downward front of the vehicle 1.

Of the part below the rear seat RS, in front of the air-intake opening portion 20O of the cooling blower 20, there is provided a wall member 10 constituting an air intake port 10O opening to bring the air AR in a vehicle interior VR into the air-intake opening portion 20O. This wall member 10 partitions the battery module 30 (on-board battery BT) and the cooling blower 20 from the vehicle interior VR. Namely, the wall member 10 serves as a side panel of the part below the rear seat RS, and the air intake port 10O opening in the wall member 10 is placed at a position lower than a seating surface SS of the rear seat RS and higher than a vehicle interior floor surface VF (rear seat floor surface RF).

Furthermore, the cooling blower 20 is positioned in a slantingly downward posture so that the axis AX of the air-intake opening portion 20O passes through the air intake port 10O of the wall member 10 and obliquely intersects at an intersection angle θ₁ with the vehicle interior floor surface VF located lower than the air intake port 10O.

The air intake port 10O is provided with a louver 11 having a plurality of fan blades 12 extending horizontally to each other and perpendicular to a paper surface of FIG. 3. An installation angle (an angle of elevation) θw of each of the fan blades 12 of the louver 11 is made equal to the intersection angle θ₁ formed by the axis AX of the air-intake opening portion 20O of the cooling blower 20 and the vehicle interior floor surface VF (rear seat floor surface RF) (θw=θ₁).

In the vehicle 1 of the present embodiment, the cooling blower 20 is placed such that the axis AX of the air-intake opening portion 20O obliquely intersects with the vehicle interior floor surface VF (rear seat floor surface RF). Thus, noise N coming out of the air-intake opening portion 20O of the cooling blower 20 advances toward the vehicle interior floor surface VF (rear seat floor surface RF) as indicated with a bold wave line in

FIG. 3 and abuts on the vehicle interior floor surface VF. Therefore, the noise reaching the occupants directly or at a short distance can be reduced. In this manner, the noise can be reduced by a simple method of adjusting a posture of the cooling blower 20, and thus a noise countermeasure with high cost-effectiveness can be obtained.

Especially, in this vehicle 1, of the vehicle interior floor surface VF (rear seat floor surface RF), a portion VF1 where the axis AX intersects is covered with a floor carpet FC, which acts as a sound absorber.

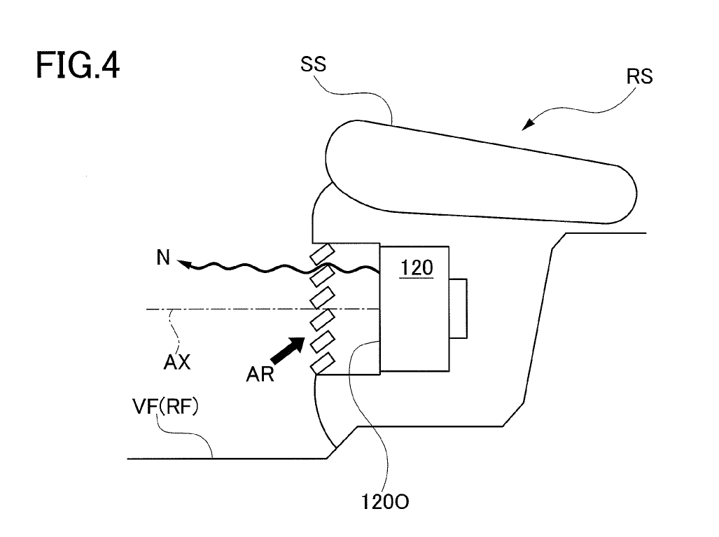

FIG. 4 shows a case which is not applied with the present invention, showing that a cooling blower 120 is mounted such that an axis AX of an air-intake opening portion 120O extends in parallel with the vehicle interior floor surface VF. In this case, unlike the present embodiment, noise N coming out of the air-intake opening portion 120O of the cooling blower 120 advances in parallel with the vehicle interior floor surface VF as shown in the figure, and hence directly reaches the occupants or reflects and thereby reaches the occupants at a short distance.

Further, the vehicle 1 of the present embodiment adopts a sirocco fan for the cooling blower 20. The sirocco fan is configured to generate higher static pressure than an axial-flow fan such as a propeller fan, so that the on-board battery BT can be efficiently cooled by adopting such a sirocco fan as the cooling blower 20.

Further, in the vehicle 1 of the present embodiment, the battery module 30 (on-board battery BT) and the cooling blower 20 are placed below the rear seat RS and the wall member 10 serves as a side panel of the part below the rear seat RS. In this case, due to insufficient space, a distance between the air intake port 10O and the air-intake opening portion 20O of the cooling blower 20 becomes short, and it tends to be difficult to take measures such as providing a sound absorber and others in front of the air-intake opening portion 20O for noise reduction.

On the contrary, in the vehicle 1, the cooling blower 20 is configured such that the axis AX of the air-intake opening portion 20O obliquely intersects with the vehicle interior floor surface (VF) (rear seat floor surface RF), and therefore the occupants' unpleasant feeling caused by the noise can be easily relieved even when the on-board battery BT and the cooling blower 20 are placed below the rear seat RS.

Further, in the vehicle 1 of the present embodiment, the wall member 10 includes a louver 11, and an installation angle θw of the fan blade 12 of the louver 11 is made equal to the intersection angle θ₁ formed by the axis AX of the air-intake opening portion 20O of the cooling blower 20 and the vehicle interior floor surface VF (rear seat floor surface RF).

By providing the louver 11 in the wall member 10, it becomes possible to prevent foreign materials from intruding into the cooling blower 20 from the air intake port 10O.

Further, in this vehicle 1, the cooling blower 20 is in a posture such that the installation angle θw of the fan blade 12 of the louver 11 is made equal to the intersection angle θ₁ formed by the axis AX of the air-intake opening portion 20O of the cooling blower 20 and the vehicle interior floor surface VF (rear seat floor surface RF). Therefore, an effective opening area of the air intake port 10O can be made large when it is seen from a cooling blower 20 side, improving air intake efficiency of the cooling blower 20 and enhancing cooling performance to cool the on-board battery BT.

In addition to this, the louver 11 guides the noise generated in the cooling blower 20 toward the vehicle interior floor surface VF (rear seat floor surface RF), thus achieving further reduction in the noise reaching the passenger directly or at a short distance.

As above, the present invention is exemplified with the present embodiment, but it is not limited to the above embodiment and may be applied with various changes without departing from the scope of its subject matter.

For example, in the present embodiment, the on-board battery BT and the cooling blower 20 are placed below the rear seat RS of the vehicle 1. As an alternative, for example, the present invention may be applied to a case that an on-board battery and a cooling blower are placed in a part below other seats in the vehicle interior VR such as a driver's seat and a front passenger seat or a third seat of a three-row vehicle.

Further, the present invention may be applied to other cases that a battery and a blower are provided in between a driver's seat and a front passenger seat and that a battery and a blower are provided in portions other than a seat, for example, providing a blower inside a vehicle inner wall and providing an air intake port on the inner wall.

### REFERENCE SIGNS LIST

1 Vehicle
BT On-board battery
RS Rear seat (seat)
SS Seating surface
VF Vehicle interior floor surface
RF Rear seat floor surface
VR Vehicle interior
10 Wall member
10O Air intake port
11 Louver
12 Fan blade
20, 120 Cooling blower (blower)
20O, 120O Air-intake opening portion
AR Air
AX Axis
M Fan motor
30 Battery module
31 Battery module case
32 Cooling duct
θ₁ Intersection angle
θw Installation angle

What is claimed is:

1. A vehicle including:
an on-board battery;
a blower provided with an air-intake opening portion for blowing air taken from the air-intake opening portion toward the on-board battery; and
a wall member placed in front of the air-intake opening portion so that the on-board battery and the blower are partitioned from a vehicle interior, the wall member configured with an air intake port opening into the air-intake opening portion to bring the air in the vehicle interior into the air-intake opening portion, wherein
the blower is placed such that an axis of the air-intake opening portion passes through the air intake port and obliquely intersects with a vehicle interior floor surface which is located lower than the air intake port.

2. The vehicle according to claim 1, wherein
the blower is a sirocco fan in which the air-intake opening portion is circularly opening, and
the axis of the air-intake opening portion is a rotary axis of a fan motor of the sirocco fan.

3. The vehicle according to claim 1, wherein
the on-board battery and the blower are placed below a seat, and
the wall member serves as a side panel positioned below the seat and the wall member is provided with the air intake port placed lower than a seating surface of the seat and higher than the vehicle interior floor surface.

4. The vehicle according to claim 2, wherein
the on-board battery and the blower are placed below a seat, and
the wall member serves as a side panel positioned below the seat and the wall member is provided with the air intake port placed lower than a seating surface of the seat and higher than the vehicle interior floor surface.

5. The vehicle according to claim 1, wherein
the wall member includes a louver placed in the air intake port and formed of a plurality of fan blades, and
an installation angle θw of the respective fan blades is equal to an intersection angle θ₁ formed by the axis of the air-intake opening portion and the vehicle interior floor surface (θw=θ₁).

6. The vehicle according to claim 2, wherein
the wall member includes a louver placed in the air intake port and formed of a plurality of fan blades, and
an installation angle θw of the respective fan blades is equal to an intersection angle θ₁ formed by the axis of the air-intake opening portion and the vehicle interior floor surface (θw=θ₁).

7. The vehicle according to claim 3, wherein
the wall member includes a louver placed in the air intake port and formed of a plurality of fan blades, and
an installation angle θw of the respective fan blades is equal to an intersection angle θ₁ formed by the axis of the air-intake opening portion and the vehicle interior floor surface (θw=θ₁).
